(19) United States
(12) Patent Application Publication
(10) Pub. No.: US 2003/0165062 A1
(43) Pub. Date: Sep. 4, 2003

(54) Collapsible lamp shade

(75) Inventors: Neall W. Humphrey, El Dorado Hills, CA (US); Steven C. Guthrie, Cameron Park, CA (US)

Correspondence Address: HAYNES AND BOONE, LLP, 901 MAIN STREET, SUITE 3100, DALLAS, TX, 75202, US

(73) Assignee: Craftmade International, Inc., Coppell, TX

(21) Appl. No.: 10/090,093

(22) Filed: Mar. 4, 2002

(51) Int. Cl. F21V 1/06

(52) U.S. Cl. 362/352; 362/356; 362/358

(57) ABSTRACT

A collapsible lamp shade is provided, having removable supports to engage an upper ring and lower ring assembly in an interference fit.

The present invention relates generally to a collapsible lamp shade.

### BRIEF DESCRIPTION OF THE DRAWINGS

FIG. 1 is a perspective view with cutaway of a lamp shade according to the present embodiment.

FIG. 2 is an isolated view of a support engaging a lower ring assembly of the lamp shade.

FIG. 3 is a cross-sectional view of FIG. 2.

FIG. 4 is a perspective view of a first embodiment of the support.

FIG. 5 is a perspective view of a second embodiment of the support.

FIG. 6a is a perspective view of the lamp shade in an extended position.

FIG. 6b is a perspective view of the lamp shade in a partially collapsed position.

FIG. 6c is a perspective view of the lamp shade in a collapsed position.

### DETAILED DESCRIPTION

Referring to FIG. 1, the present disclosure relates to a collapsible lamp shade, generally given the reference number 10. It is understood that the lamp shade 10 may take a variety of decorative shapes.

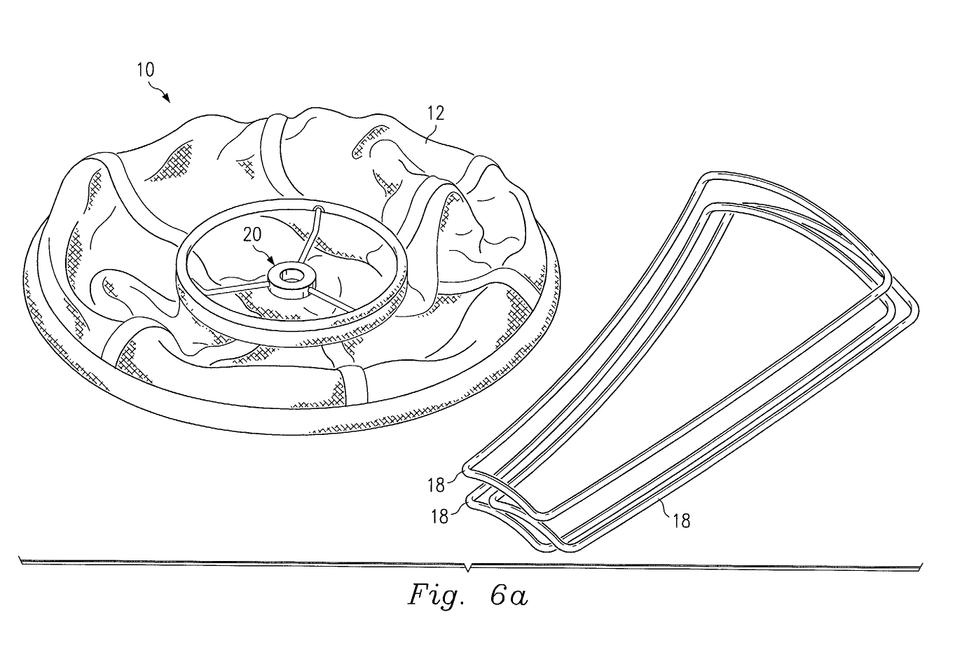

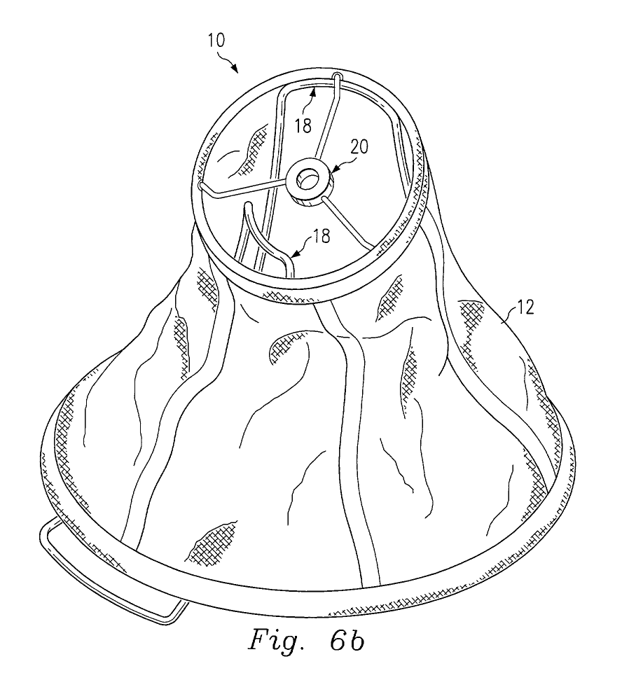

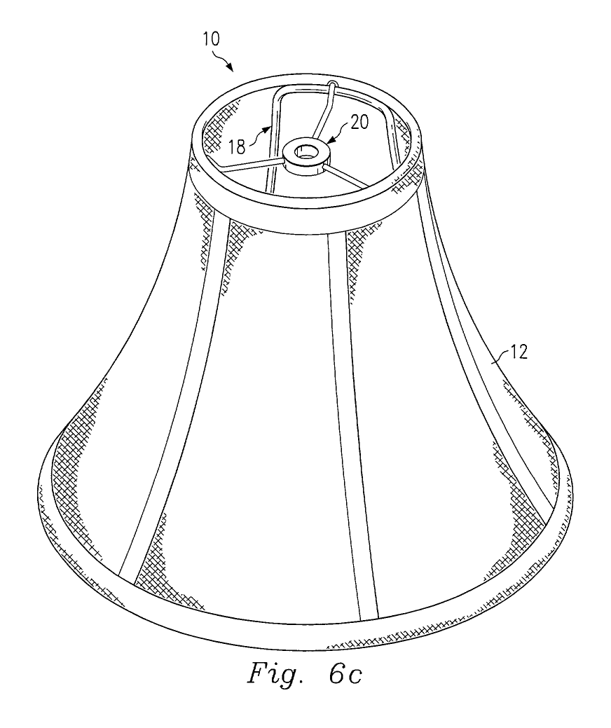

The lamp shade 10 includes a shade cover 12. The shade cover 12 is made of a material (e.g., fabric) sufficiently supple to allow the lamp shade 10 to be collapsed, as will be discussed in detail below with reference to FIGS. 6a-c, from the extended position illustrated in FIG. 1. However, the shade cover 12 has sufficient rigidity to allow the shade cover to be stretched taut, and to remain taut, while the lamp shade is in the extended position. The shade cover 12 also must be resistant to heat within generally known industry standards.

The shade cover 12 is attached to and disposed between an upper ring 14 and a lower ring assembly 16. It is understood that the upper ring 14 and the lower ring assembly 16 may have differing diameters. Alternatively, in one embodiment, for example in a barrel lamp shade (not depicted), the upper ring 14 and the lower ring assembly 16 may be of the same diameter. A collapsible barrel lamp shade is particularly advantageous, as barrel lamp shades cannot be stacked one on top of another, and thus incur a very high freight cost.

As depicted in FIG. 1, the shade cover 12 obscures the upper ring 14 and the lower ring assembly 16 from view. In the extended position of the lamp shade 10, a support 18 engages the upper ring 14 and the lower ring assembly 16 in an interference fit to stretch the shade cover 12 taut. The support 18 is of a length appropriate to the height of the lamp shade 10 in its extended position. It is understood that the support 18 achieves the interference fit solely by the tension provided the shade cover 12, and is not attached to the upper ring 14 or the lower ring assembly 16. As the upper ring 14 and the lower ring assembly 16 provide no specific engagement location for the support 18, the support may engage the upper ring and the lower ring assembly at any location along their respective circumferences.

The upper ring 14 includes an attachment means 20 for attaching the lamp shade 10 to a conventional lamp. For example, the attachment means 20 may be a conventional spider, comprising a central ring 22 connected to the upper ring 14 by a plurality of legs 24. It is understood that for the sake of simplicity, this specification uses the same reference numeral for components that are substantially identical, such as the legs 24. In one embodiment, the support 18 may engage the upper ring 14 at position proximate to any of the legs 24. Alternatively, the attachment means may be associated with the lower ring assembly 16.

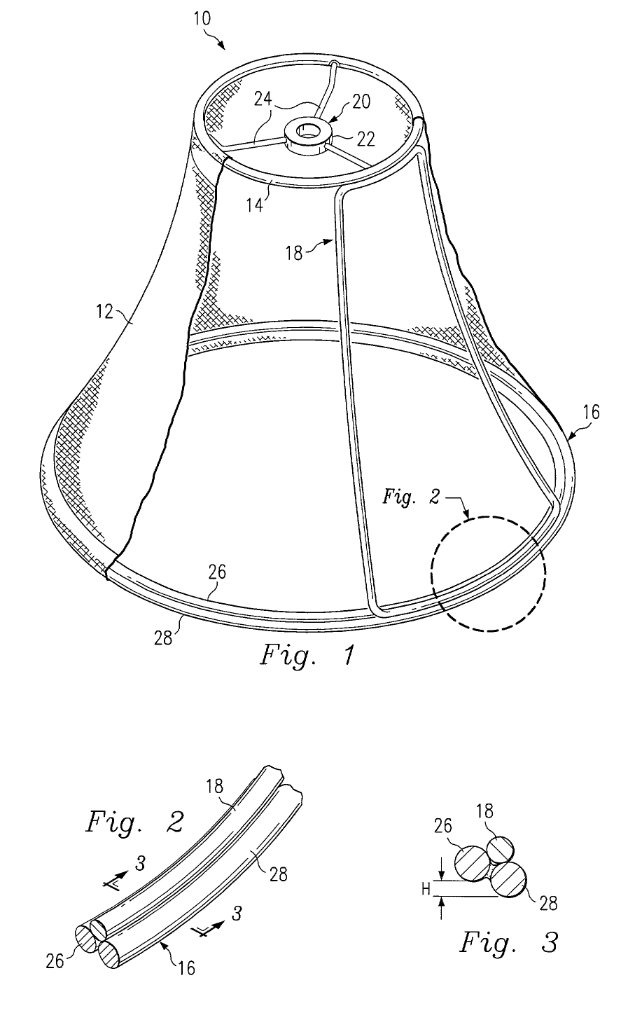

Turning to FIGS. 2-3, the lower ring assembly 16 comprises an inner ring 26 connected to an outer ring 28. As can be appreciated, this arrangement provides greater strength than one ring, even one of a larger gauge. Together, the inner ring 26 and the outer ring 28 define a groove. The support 18 engages the groove while the lamp shade is in the extended position (FIG. 1). As seen in FIG. 3, the inner ring 26 is not in the same plane as the outer ring 28, the difference in height is given the reference numeral “H.” The difference H helps retain the support 18 during movement between the extended and collapsed positions of the lamp shade 10, as will be explained with reference to FIGS. 6a-c.

A plurality of supports substantially identical to support 18 may be used. The supports 18 may be curved along their longitudinal axis to conform with the shape of the lamp shade 10. Alternatively, the supports 18 may be shaped to impart a decorative feature, such as a rib, through the shade cover 12.

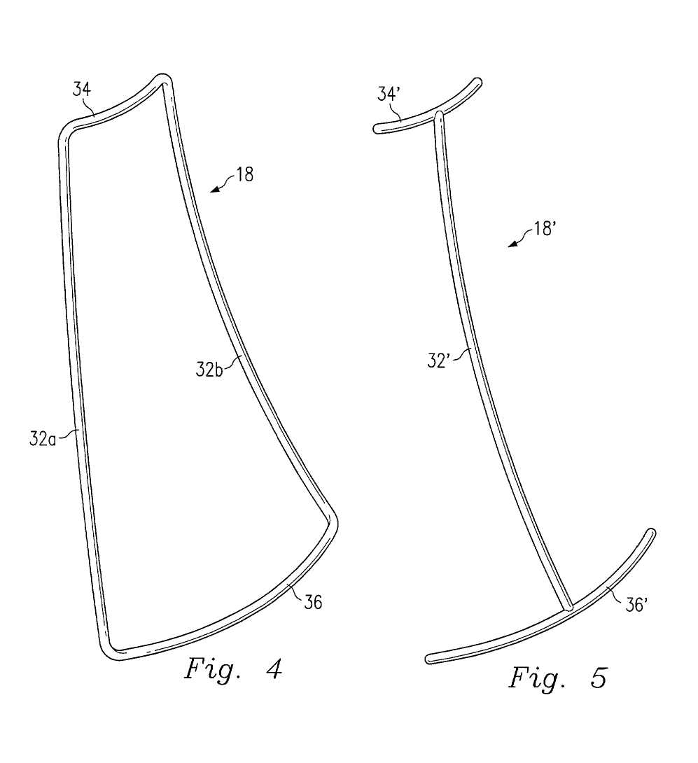

Referring now to FIG. 4, in one embodiment, the support 18 has a pair of shafts 32a-b. The shafts 32a-b may be curved along their longitudinal axis, for example, to conform with the shape of the lamp shade 10. Alternatively, the shafts 32a-b may be straight. A cross-member 34 is disposed at one end of the shafts 32a-b to connect the shafts together. The cross-member 34 forms a curve with substantially the same radius of curvature as the upper ring 14.

A second cross-member 36 is disposed at the other end of the shafts 32a-b to connect the shafts together. The cross-member 36 forms a curve with substantially the same radius of curvature as the lower ring assembly 16. In the extended position of the lamp shade 10 (FIG. 1), the cross-member 36 is disposed in the groove defined between the inner and outer rings 26, 28. It is understood that different numbers of shafts substantially identical to shafts 32a-b are contemplated.

Referring now to FIG. 5, in an alternative embodiment of the support 18, a support 18′ is provided. The support 18′ is substantially I-shaped, with a shaft 32′ extending between cross-members 34′ and 36′. The cross-member 34′ forms a curve with substantially the same radius of curvature as the upper ring 14, and the cross-member 36′ forms a curve with substantially the same radius of curvature as the lower ring assembly 16. In the extended position of the lamp shade 10, the cross-member 36′ is disposed in the groove defined between the inner and outer rings 26, 28. It is understood that the shaft 32′ may be curved along its longitudinal axis, for example, to conform with the shape of the lamp shade 10. Alternatively, the shaft 32′ may be straight.

Referring to FIGS. 6a-c, the lamp shade 10 is illustrated in a collapsed position (FIG. 6a), a partially extended intermediate position (FIG. 6b) and the extended position (FIG. 6c). The collapsed position is desirable for shipping the lamp shade 10, for example from a manufacturer or a supplier. The extended position of the lamp shade is optimal for use as a lamp shade, as well as for display relating to sale of an individual lamp shade or in conjunction with a lamp. It is understood that the partially extended intermediate position is transitory, and is illustrated to aid explanation of the operation.

In operation, the lamp shade 10 is moved from the collapsed position (FIG. 6a) to the extended position (FIG. 6c) by a user. The user takes one of a plurality of supports 18 and aligns the cross-member 36 of the support with the groove of the lower ring assembly 16. The support 18 is the rotated, using the cross-member 36 as a fulcrum. As the support 18 is rotated, the cross-member 34 of the support may contact the attachment means 20, pushing the upper ring 14 away from the lower ring assembly 16 and stretching the shade cover 12 taut. The cross-member 34 finally engages the upper ring 14 and is held in an interference fit. In the present embodiment, the upper cross-member 34 may also press against one of the legs 24 of the spider. A second support 18 may be inserted in the same manner, and further supports 18 may also be inserted in the same manner.

Although not depicted, it is understood that the support 18′ (FIG. 5) is operated in the same manner, e.g., a user would take one of a plurality of supports 18′ and align the cross-member 36′ of the support with the groove of the lower ring assembly 16. The support 18′ would be rotated, using the cross-member 36′ as a fulcrum. As the support 18′ is rotated, the cross-member 34′ of the support may contact the attachment means 20, pushing the upper ring 14 away from the lower ring assembly 16 and stretching the shade cover 12 taut. The cross-member 34′ finally engages the upper ring 14 and is held in an interference fit.

Should the user desire to move the lamp shade 10 from the extended position (FIG. 6c) to the collapsed position (FIG. 6a), the user applies rotational force to the support 18, using the cross-member 36 as a fulcrum, to overcome the interference fit. The user then removes the support 18 from the lamp shade 10. Additional supports 18 (or 18′) may also be removed in the same manner. As can be readily appreciated, the absence of supports 18 from the lamp shade 10 allows it to fold flatter than if the supports were laid inside the collapsed lamp shade.

Although only a few exemplary embodiments of this invention have been described in detail above, those skilled in the art will readily appreciate that many modifications are possible in the exemplary embodiments without materially departing from the novel teachings and advantages of this invention. For example, it may be desirable that one or both of the cross-members members 34, 34′, 36, or 36′, include a friction increasing means to prevent slippage. Accordingly, all such modifications are intended to be included within the scope of this invention as defined in the following claims.

What is claimed is:

1. A lamp shade for moving between a collapsed position and an extended position, comprising:
an upper ring;
a ring assembly;
a shade cover disposed between the upper ring and the ring assembly; and
a support comprising a shaft and a pair of curved cross-members, wherein in the extended position, the support engages the upper ring and the ring assembly in an interference fit, stretching the shade cover taut.

2. The lamp shade of claim 1 wherein the second ring comprises an inner ring and an outer ring connected together to define a groove for receiving one of the cross-members.

3. The lamp shade of claim 2 wherein the inner ring is not in the same plane as the outer ring.

4. The lamp shade of claim 1 further comprising an attachment means for attaching the lamp shade to a lamp.

5. The lamp shade of claim 1 wherein the support has a pair of shafts extending between the cross-members.

6. The lamp shade of claim 1 wherein the first cross-member forms a curve with substantially the same radius of curvature as the upper ring.

7. The lamp shade of claim 1 wherein the second cross-member forms a curve with substantially the same radius of curvature as the lower ring assembly.

8. The lamp shade of claim 1 wherein the shaft is curved.

9. The lamp shade of claim 1 wherein the shaft is straight.

10. A lamp shade for moving between a collapsed position and an extended position, comprising:
an upper ring;
a ring assembly comprising an inner ring and an outer ring connected together to define a groove;
a shade cover disposed between the upper ring and the ring assembly; and
a support comprising a shaft and a pair of curved cross-members, wherein in the extended position, the support engages the upper ring and the groove defined by the ring assembly in an interference fit, stretching the shade cover taut.

11. The lamp shade of claim 10 wherein the inner ring is not in the same plane as the outer ring.

12. The lamp shade of claim 10 further comprising an attachment means for attaching the lamp shade to a lamp.

13. The lamp shade of claim 10 wherein the support has a pair of shafts extending between the cross-members.

14. The lamp shade of claim 10 wherein the first cross-member forms a curve with substantially the same radius of curvature as the upper ring.

15. The lamp shade of claim 10 wherein the second cross-member forms a curve with substantially the same radius of curvature as the lower ring assembly.

16. The lamp shade of claim 10 wherein the shaft is curved.

17. The lamp shade of claim 10 wherein the shaft is straight.

18. A method for extending a collapsible lamp having a shade cover disposed between an upper ring and a ring assembly, comprising:
providing a support comprising a shaft and a pair of curved cross-members;
engaging the ring assembly with the support;
rotating the support until it engages the upper ring, thereby stretching the shade cover taut; and
retaining the support between the upper ring and the ring assembly in an interference fit.

19. A support for a collapsible lamp having a shade cover disposed between an upper ring and a ring assembly, comprising:
a shaft;
a pair of curved cross-members attached to the shaft, wherein in an extended position of the lampshade, the support engages the upper ring and the ring assembly in an interference fit, stretching the shade cover taut.

20. The support of claim 19 further comprising a second shaft extending between the cross-members.

21. The support of claim 19 wherein the first cross-member forms a curve with substantially the same radius of curvature as the upper ring.

22. The support of claim 19 wherein the second cross-member forms a curve with substantially the same radius of curvature as the lower ring assembly.

23. The support of claim 19 wherein the shaft is curved.

24. The support of claim 19 wherein the shaft is straight.

25. A ring assembly for a collapsible lamp having a shade cover disposed between an upper ring and the ring assembly, comprising:
an inner ring and an outer ring connected together to define a groove for receiving a support to engage the upper ring and the ring assembly in an interference fit to stretch the shade cover taut.

26. The ring assembly of claim 25 wherein the inner ring is not in the same plane as the outer ring.
